(19) United States
(12) Patent Application Publication
(10) Pub. No.: US 2026/0326141 A1
(43) Pub. Date: Oct. 22, 2026

(54) WOOD SHINGLE / SHAKE COATER FOR ENHANCED COATING EFFICIENCY AND UNIFORMITY

(71) Applicants: James Ogden, Ashland, NH (US); Nathen Forde, Ashland, NH (US)

(72) Inventors: James Ogden, Ashland, NH (US); Nathen Forde, Ashland, NH (US)

(21) Appl. No.: 19/181,339

(22) Filed: Apr. 17, 2025

(51) Int. Cl. B05C 11/04; B05C 3/10

(52) U.S. Cl. CPC B05C 11/044; B05C 3/10; B05C 11/045

(57) ABSTRACT

A coater for efficiently and uniformly applying a coating liquid to wooden shingles and wooden shakes. The coater includes a first rail and a second rail in parallel relationship, and connected by two perpendicular brackets. Each of the two perpendicular brackets includes an adjustability feature for adjusting the separation distance between the first and second horizontal squeegees. There is a first horizontal squeegee mounted to the first rail, and a second horizontal squeegee mounted to the second rail, which is in spaced and confronting relationship with the first rail. A single vertical squeegee for removing excess coating from edges of the shingle or shake is mounted on the first or second rail. Also included is an accessory sponge for wiping excess coating liquid from a shingle or shake, the sponge attached to at least one of the first and second rails.

### FIELD OF THE INVENTION

The invention relates generally to devices for applying coatings to wood shingles and shakes, and particularly to devices for efficiently applying coatings to wood shingles and shakes.

### BACKGROUND OF THE INVENTION

A wood shingle is a small thin piece of wood, such as such as pine, cedar, or aspen, typically with one end thicker than the other end. Such shingles are commonly used for covering a roof, or covering the sides of a building, by laying them in overlapping rows.

Some shingles are called “shakes”. A shake is a shingle that is split from a piece of a log, usually three or four feet long. Shingles are mostly made by being cut, which distinguishes them from shakes, which are made by being split out of a bolt of wood.

Shakes and shingles are used to cover roofs and walls of buildings to protect them from the weather. Higher-grade shingles and shakes are typically used for roofing, while the lower grades are used for siding. Shakes and shingles are often treated with wood preservatives and fire retardants before or after installation. Shakes and shingles can also be coated with paint or varnish or polyethylene or polyurethane to improve the look and durability of the wood.

However, the usual method of painting or coating wood shingles involves either using a brush or a sprayer. In both cases, the process is tedious, time-consuming, non-uniform, and wasteful of coating material.

### SUMMARY OF THE INVENTION

The Wood Shingle / Shake Coater saves time, coating material, and allows more uniform application of a coating to a shake or shingle. Such coatings include: paint, stain, varnish, polyethylene, and polyurethane, for example.

The Wood Shingle / Shake Coater helps to coat or paint or stain or finish or pre-finish or dip or apply paint or stain or varnish or polyurethane or polyethylene to a shake or shingle made from pine, cedar or aspen, quickly, easily, and uniformly.

The Wood Shingle / Shake Coater can be used by placing it on the top opening of a bucket, pail, or other container. For example, a five-gallon bucket or pail is a good size to use.

Instead of a pair of horizontal squeegees, a pair of horizontal brushes, horizontal felt applicators, or foam applicators can be used.

The first and second parallel rails are connected by two perpendicular brackets, and in some embodiments, each of the two perpendicular brackets include a feature to enable adjustment of the spacing between the two squeegees (coating fins) for different types of finish, and/or different minimum thicknesses of the shingle or shake to be coated.

A general aspect of the invention is a wood shingle / shake coater for efficiently and uniformly applying a coating liquid to a shingle or a shake. The coater is intended for use with a bucket or vessel or pail. The coater includes: a first rail and a second rail in parallel relationship, the first and second parallel rails connected by two perpendicular brackets; a first horizontal squeegee mounted to the first rail, and a second horizontal squeegee mounted to the second rail, the first and second horizontal squeegees in spaced and confronting relationship, a space between the first and second horizontal squeegees being less than a minimum thickness of a shingle / shake to be coated; and a single vertical squeegee mounted on the first rail or the second rail, the single vertical squeegee configured to be used to remove excess coating from edges of the shingle / shake.

In some embodiments, each of the two perpendicular brackets includes an adjustability feature configured to adjust the separation distance between the first horizontal squeegee and the second horizontal squeegee.

In some embodiments, the coater further includes: an accessory sponge resting on at least one of the first and second rails, the accessory sponge configured to be used for wiping excess coating liquid from a shingle.

In some embodiments, each squeegee is replaced by a pair of: brushes, or felt applicators, or foam applicators, each pair being configured to remove excess liquid from a shingle / shake passing through the pair, the pair being mounted on the two rails.

In some embodiments, the coater further includes: a bucket or vessel or pail, the bucket or vessel or pail having a top opening, the first rail and the second rail resting over the top opening of the bucket or vessel or pail.

In some embodiments, the bucket or container or pail is configured to contain at most five gallons of coating.

Another general aspect of the invention is a wood shingle / shake coater for efficiently and uniformly applying a coating liquid to a shingle or a shake. This coater includes: a first rail and a second rail in parallel relationship, the first and second parallel rails connected by two perpendicular brackets; a first horizontal squeegee mounted to the first rail, and a second horizontal squeegee mounted to the second rail, the first and second horizontal squeegees in spaced and confronting relationship, a space between the first and second horizontal squeegees being less than a minimum thickness of a shingle / shake to be coated; and a bucket or vessel or pail, the bucket or vessel or pail having a top opening, the first rail and the second rail resting over the top opening of the bucket or container or pail.

In some embodiments, each of the two perpendicular brackets includes an adjustability feature configured to adjust the separation distance between the first horizontal squeegee and the second horizontal squeegee.

In some embodiments, the wood shingle / shake coater further includes: a single vertical squeegee mounted on the first rail or the second rail, the single vertical squeegee configured to be used to remove excess coating from edges of the shingle / shake.

In some embodiments, the bucket or container or pail can contain at most five gallons of coating.

In some embodiments, each squeegee is replaced by a pair of brushes, or felt applicators, or foam applicators, each pair being configured to remove excess liquid from a shingle / shake passing through the pair, the pair being mounted on the two rails.

In some embodiments, the wood shingle / shake coater further includes: a sponge mounted on the first rail or the second rail, the sponge configured to be used to remove excess coating from edges of the shingle / shake.

### BRIEF DESCRIPTION OF THE DRAWINGS

Many additional features and advantages will become apparent to those skilled in the art upon reading the following description, when considered in conjunction with the accompanying drawings, wherein:

FIG. 1A is a perspective view of an embodiment of the shingle /shake coater, showing two horizontal squeegees for applying coating liquid to a shingle or shake, the squeegees mounted on two rails connected by two perpendicular brackets, the two horizontal squeegees almost touching, also showing a single vertical squeegee for removing excess coating liquid from the edges of the shingle or shake, the single vertical squeegee mounted on one of the rails, as well as showing an accessory sponge attached to at least one of the two parallel rails, the sponge being for wiping excess coating liquid from shingles or shakes.

FIG. 1B is a perspective view of the embodiment of FIG. 1A, showing the two horizontal squeegees separated by a larger gap than the gap shown in FIG. 1A.

FIG. 2A is a perspective view of the embodiment of FIG. 1, shown resting on an open bucket that contains a coating liquid for coating a shingle or shake.

FIG. 2B is a perspective view of a shake to be coated using the embodiment shown in FIG. 2A.

FIG. 3 is a sectional side view of the embodiment of FIG. 2A, showing a bottom portion of a shingle or shake held in position to be inserted between the two horizontal squeegees, before being dipped into the coating liquid contained in the bucket.

FIG. 4 is a sectional side view of the embodiment of FIG. 2A, showing the shingle or shake being pushed down between squeegees and dipped fully into the coating liquid until the leading edge of the shingle or shake contacts the bottom of the bucket.

FIG. 5 is a sectional side view of the embodiment of FIG. 2A, showing the shingle or shake being pulled up through the two horizontal squeegees to remove excess coating liquid from the front and rear surfaces of the shingle or shake.

FIG. 6 is a sectional side view of the embodiment of FIG. 2A, showing the long edge of the shingle being pulled back over the single vertical squeegee to remove excess coating liquid from long edge of the shingle or shake.

FIG. 7 is a sectional side view of the embodiment of FIG. 2A, showing the short edge of the shingle or shake being pulled back over the single vertical squeegee to remove excess coating liquid from short edge of the shingle or shake.

FIG. 8 is a side view of two coated shingles / shakes hung up to dry after being coated using the embodiment of FIG. 2A.

### DETAILED DESCRIPTION

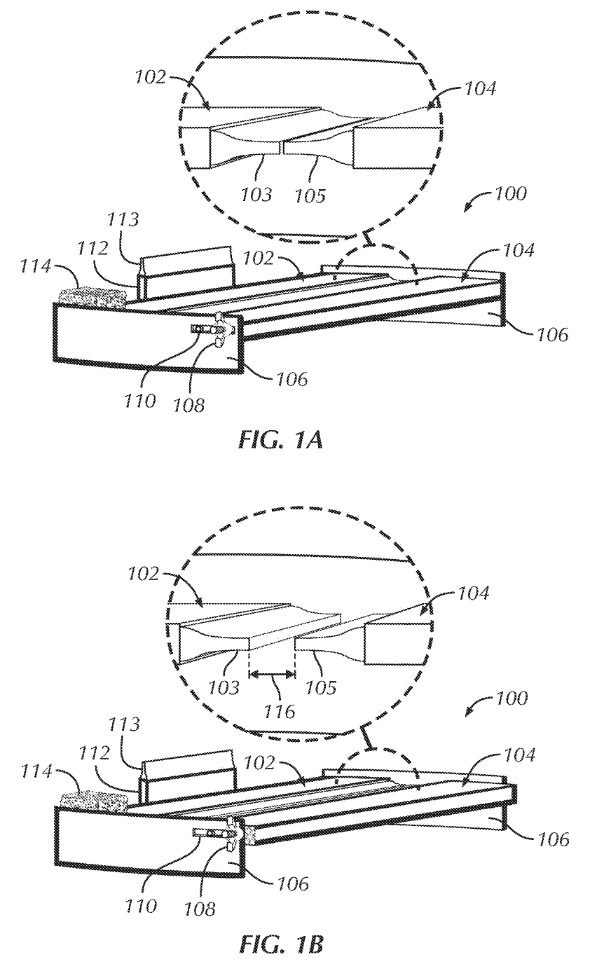

With reference to FIG. 1A, an embodiment of a shingle / shake coater 100 is shown. The shingle / shake coater 100 includes a first rail 102, a second rail 104, a first horizontal squeegee 103 attached to the first rail 102, and a second horizontal squeegee 105 attached to the second rail 104. The coater 100 also includes a pair of perpendicular brackets 106 that support the first and second rails 102, 104 that extend perpendicularly between the two perpendicular brackets 106. Also shown is a bolt / wingnut 108, and a slot 110 in each of the perpendicular brackets 106 that allows the second rail 104 to be moved towards or away from the first rail 102 to adjust a separation distance 116 (FIG. 1B) between the first and second horizontal squeegees 103, 105. The wingnut 108 is tightened within the slot 110 to fix the second rail 104 in position at a desired separation distance 116 (FIG. 1B). The first and second rails 102, 104 can be manufactured using a durable material, such as plastic or metal.

The first and second horizontal squeegees 103, 105 are made from flexible rubber, as is commonly known and understood by those skilled in the art. The first and second horizontal squeegees 103, 105 can be fixedly attached to the respective first and second rails 102, 104 using adhesive, for example.

The shingle / shake coater 100 further includes a vertical squeegee 113 for removing excess coating from the narrow sides of a shingle / shake. The vertical squeegee 113 is mounted to a vertical rail 112 that is rigidly attached to the first horizontal rail 102 in a manner similar to the attachment of the first and second horizontal squeegees 103, 105 to the first and second rails 102, 104. The vertical rail 112 can be fixedly attached to the side of the first rail 102 opposite to the side bearing the first horizontal squeegee 103.

The shingle / shake coater 100 further includes an accessory sponge 114 that is attached to one of the two perpendicular brackets 106. The accessory sponge 114 can be used to wipe excess liquid from a shingle / shake.

Referring to FIG. 1B, the second rail 104 is adjustably attached to the perpendicular brackets 106 via a pair of bolts and a pair of cooperative wing nuts 108. Each perpendicular bracket 106 contains a slot 110 extending from near a proximal end of each of the brackets 106 to a distance equal to the maximum separation distance between the first and second horizontal squeegees 103, 105. A bolt is inserted into a hole in each end of the first and second rails 102, 104. Each bolt extends outwardly from the first and second rails 102, 104 through the slots 110 of the perpendicular brackets 106. A wing nut 108 engages each bolt that extends through each perpendicular bracket 106. To adjust the separation distance 116 between the horizontal squeegees 103, 105, a user can loosen the wing nuts to enable the bolts to slide freely within the slots 108 of the perpendicular brackets 106. The first and second rails 102, 104 will move along with the bolts, thereby changing the separation distance 116 between the horizontal squeegees 103,105. Once the user has adjusted the separation distance 116 between the horizontal squeegees 103, 105, the user then tightens the wing nuts 108, thereby securing the first and second rails 102, 104 in place.

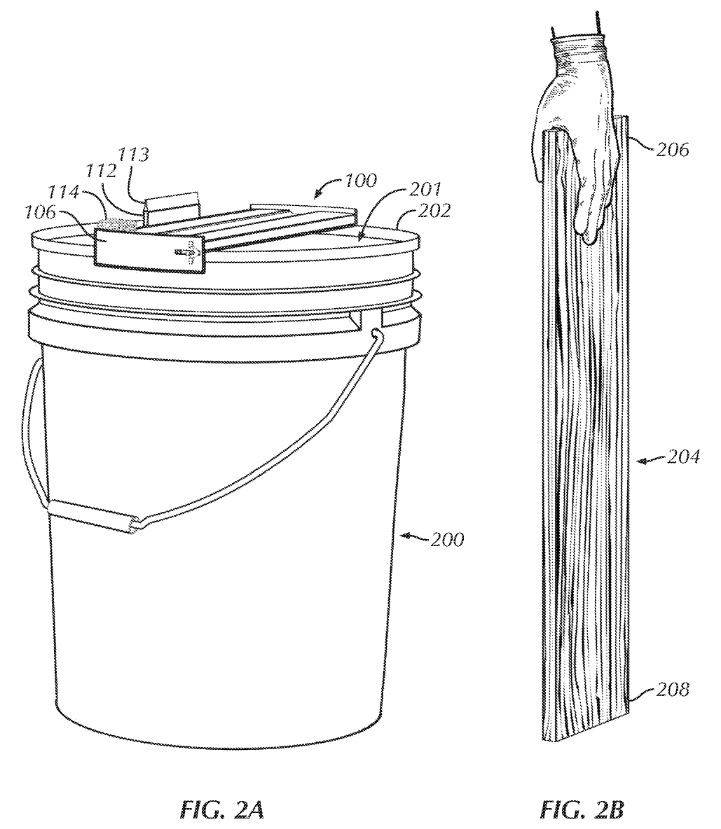

With reference to FIG. 2A, an embodiment of the shingle / shake coater 100 is shown placed for use on top of a receptacle or bucket 200. It 100 is placed over the open area 201 of the bucket or receptacle 200. The preferred placement of the shingle / shake coater 100 over the open area 201 of the bucket 200 is achieved by aligning the space between the horizontal squeegees 116 with the central portion of the top opening 201 of the bucket 200.

In embodiments wherein the separation distance 116 between the horizontal squeegees 103, 105 can be adjusted, the separation 116 is adjusted by loosening the wingnuts 108, and then moving the rail 104 so that the separation 116 between the squeegees 103, 105 is slightly less than the narrowest width of the shingle / shake 204 to be coated, and then retightening the wingnuts 108.

FIG. 2B shows a shingle / shake 204 to be coated using the shingle / shake coater 100. The upper end 206 is typically wider than the lower end 208.

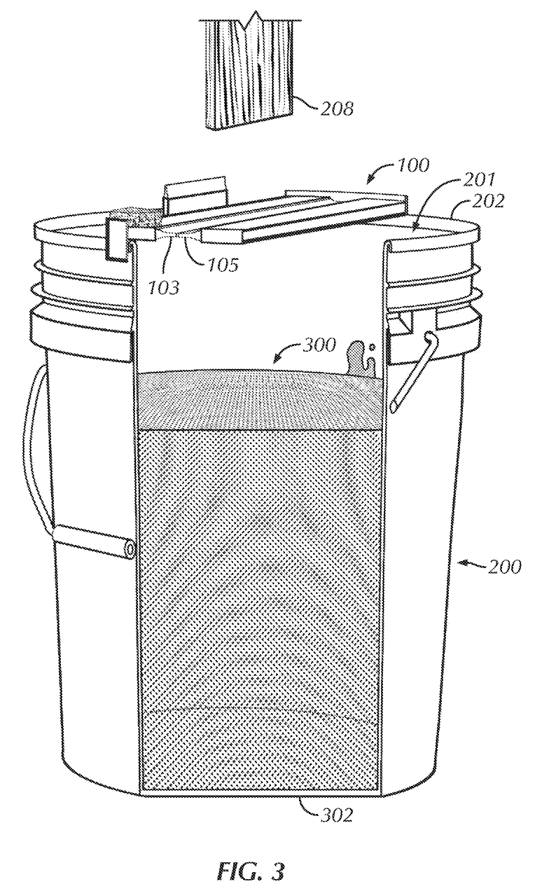

Referring now to FIG. 3, an embodiment of the shingle / shake coater 100 is shown placed on the rim 202 of the opening 201 of a bucket 200 that has been filled with a liquid 300 to be applied as a coating to the shingle 204, starting with the lower end 208. Thus, to use the coater 100, the lower end 208 of the shingle 204 to be coated is held over the squeegees 103, 105 of the coater 100.

The bucket 200 should be partially filled with a coating liquid 300, such as stain or varnish, before placing the shingle / shake coater 100 on top of the bucket 200. For example, the shingle / shake coater 100 is placed on the rim 202 of a 5-gallon bucket 200.

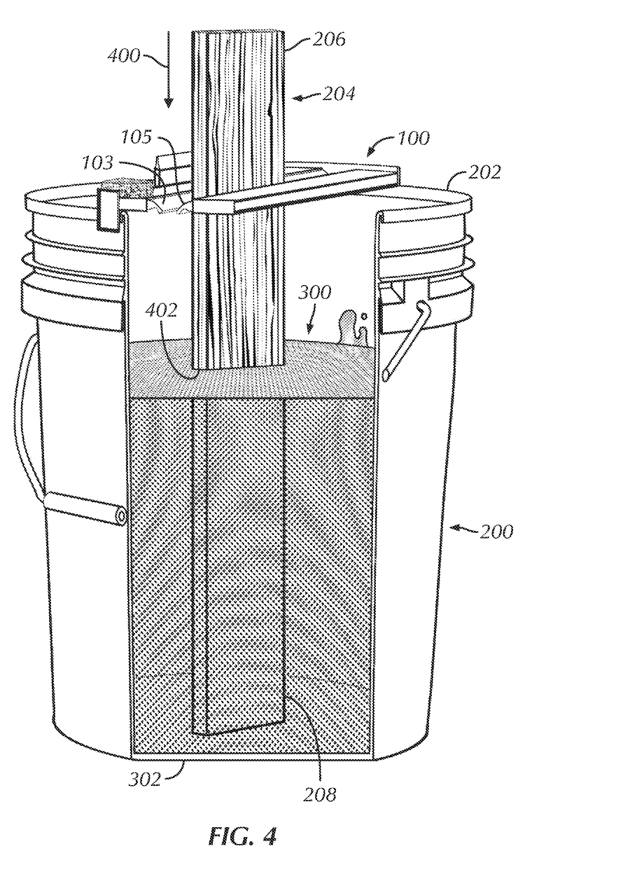

Referring to FIG. 4, the user then pushes the shingle 204 downward 400 through the squeegees 103, 105 and into the bucket 200, continuing downward into the liquid 300 until the lower end 208 of the shingle 204 contacts the bottom 302 of the bucket 200. By ensuring that the shingle 204 contacts the bottom 302 of the bucket 200, the user ensures that each shingle 204 is coated evenly and uniformly.

Referring again to FIG. 4, a shingle 204 is shown after being pushed downwardly 400 through the separation 116 between the horizontal squeegees 103, 105 of the shingle / shake coater 100, into the bucket 200, until the bottom end 208 of the shingle 204 contacts the bottom 302 of the bucket 200. The shingle 204 is thereby submerged in the coating liquid 300, which coats the shingle 204 up to a consistent point 402 along the shingle 204. The horizontal squeegees 103, 105 are bending downwardly as the shingle 204 passes downwardly between the squeegees 103, 105.

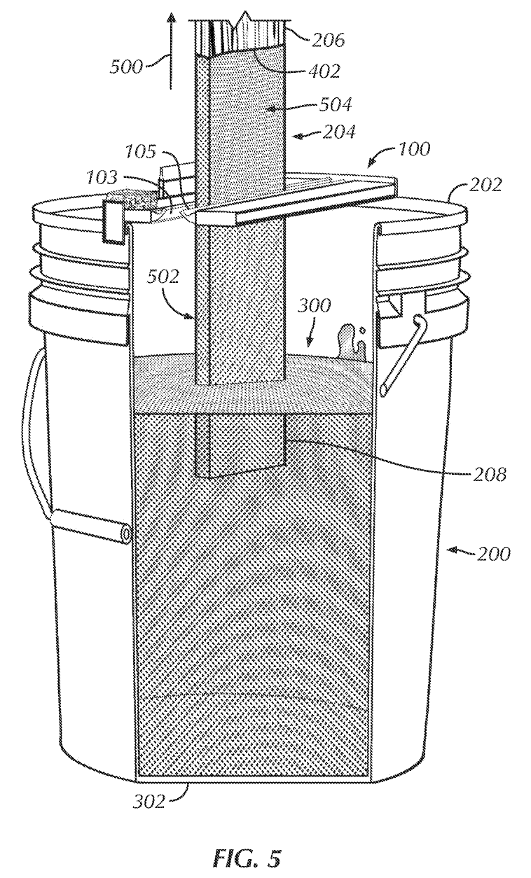

With reference to FIG. 5, a shingle 204 is shown being pulled upwardly 500 through the horizontal squeegees 103, 105. As the shingle 204 is pulled upwardly 500 through the horizontal squeegees 103, 105, they bend upwards as they wipe off excess coating liquid 300 from the shingle 204. A wiped portion 504 of the shingle 204 is shown, having passed through the shingle / shake coater 100, and an unwiped portion 502 of the shingle 204 is shown, having not yet passed through the horizontal squeegees 103, 105. The shingle 204 has been coated up to the desired extent 402 as a result of passing through the shingle / shake coater 100, into the coating liquid 300, until the end 208 of the shingle 204 reaches the bottom 302 of the bucket 200.

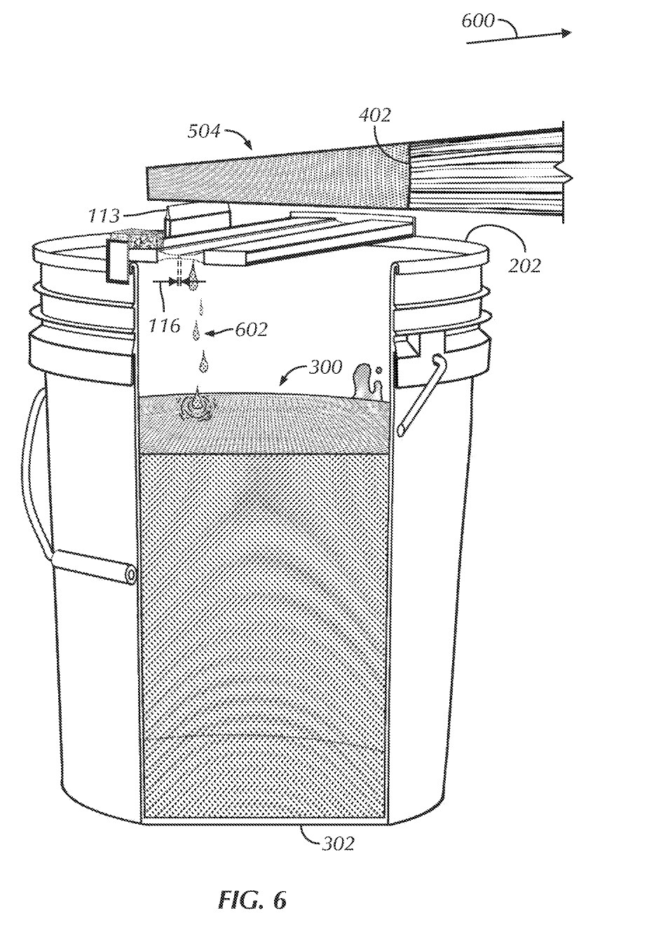

Referring to FIG. 6, a shingle 204 is shown after being coated with the coating liquid 300, and after being pulled upwardly through the squeegees 103, 105. The shingle 204 is then dragged by the user horizontally 600 across the vertical squeegee 113 to remove excess coating liquid 300 that was not wiped off the narrow sides 504 of the shingle 204 when passing through the horizontal squeegees 103, 105. As the narrow sides 504 of the shingle 204 are being pulled horizontally 600 across the vertical squeegee 113, drops of excess liquid 602 drip back into the bucket 200 for later use, thereby reducing waste. The preferred method of wiping liquid off a shingle 204 using the vertical squeegee 113 is to start with the shingle 204 on the side furthest away from the opening 201 of the bucket 200, and proceed by pulling the shingle 204 across the vertical squeegee 113 towards the opening 201 of the bucket 200, so that the excess coating liquid 300 thereby wiped off drips back into the bucket 200 for future use.

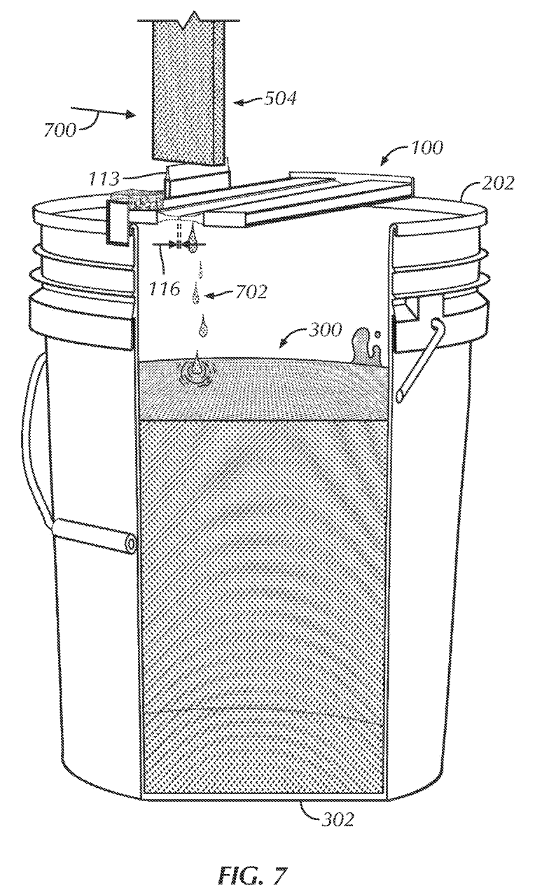

With reference to FIG. 7, a shingle 204 is shown after excess coating liquid 300 has been wiped off the edges 504 of the shingle 204. Next, the bottom narrow surface of the coated lower end 208 of the shingle 204 is pulled across 700 the vertical squeegee 113 to wipe off excess coating liquid 300. The preferred method of pulling 700 the lower end 208 across the vertical squeegee 113 is to start with the lower end 208 on the outer side of the vertical squeegee 113, and to pull the lower end 208 across the vertical squeegee 113 towards two squeegees 103, 105. Drops of excess liquid from the lower end 208 are shown dripping back 702 into the bucket 200 for re-use.

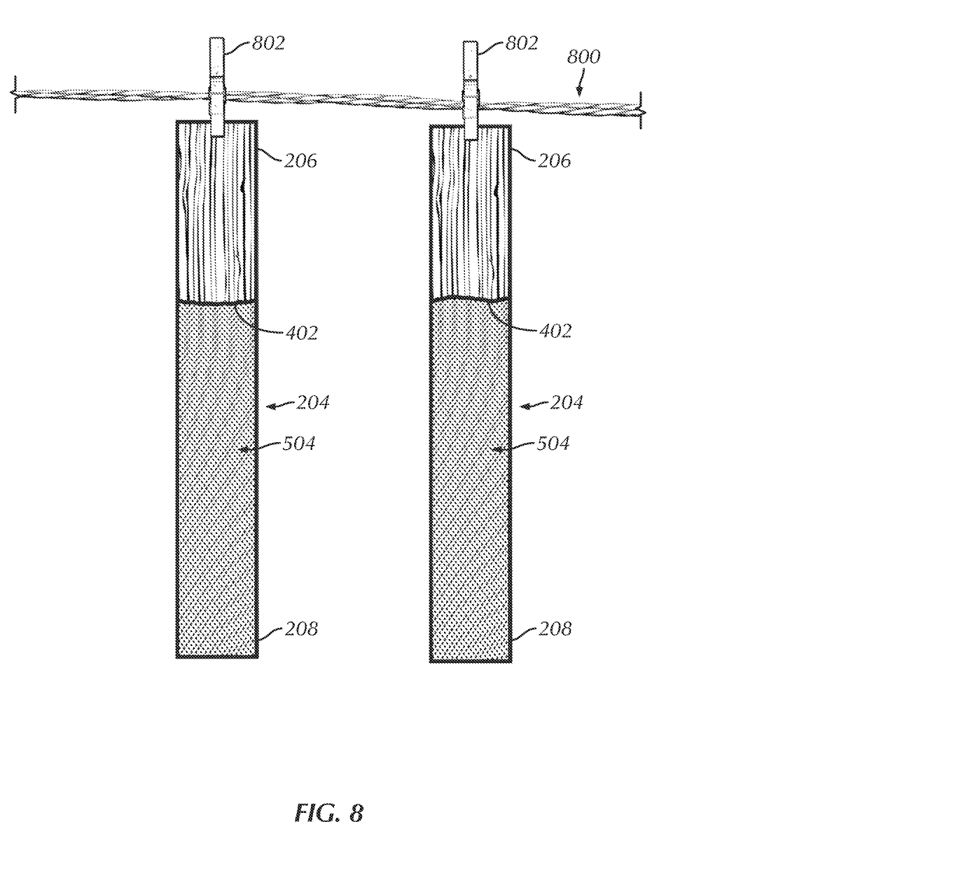

Referring now to FIG. 8, a pair of shingles 204 are shown after being coated to a uniform length 402. The shingles 204 are attached to clothes pins 802 and hanging from a clothes line 800 via the clothes pins 802 to dry the coating. The uncoated top ends 206 of the shingles 204 are oriented upwardly and closest to the clothes line 800. The shingles 204 have been consistently coated to an equal and uniform extent 402 by passing through the shingle / shake coater 100, and contacting the bottom 302 of the bucket 200, thereby providing an efficient process for easily and evenly coating shakes and shingles 204 suitable for commercial use.

Other modifications and implementations will occur to those skilled in the art without departing from the spirit and the scope of the invention as claimed. Accordingly, the above description is not intended to limit the invention, except as indicated in the following claims.

What is claimed is:

1. A wood shingle / shake coater for efficiently and uniformly applying a coating liquid to a shingle or a shake, the coater for use with a bucket or vessel or pail, the coater comprising:
a first rail and a second rail in parallel relationship, the first and second parallel rails connected by two perpendicular brackets;
a first horizontal squeegee mounted to the first rail, and a second horizontal squeegee mounted to the second rail, the first and second horizontal squeegees in spaced and confronting relationship, a space between the first and second horizontal squeegees being less than a minimum thickness of a shingle / shake to be coated; and
a single vertical squeegee mounted on the first rail or the second rail, the single vertical squeegee configured to be used to remove excess coating from edges of the shingle / shake.

2. The wood shingle / shake coater of claim 1, wherein each of the two perpendicular brackets includes an adjustability feature configured to adjust the separation distance between the first horizontal squeegee and the second horizontal squeegee.

3. The wood shingle / shake coater of claim 1, further comprising:
an accessory sponge resting on at least one of the first and second rails, the accessory sponge configured to be used for wiping excess coating liquid from a shingle.

4. The wood shingle / shake coater of claim 1, wherein each squeegee is replaced by a pair of:
brushes, or felt applicators, or foam applicators,
each pair being configured to remove excess liquid from a shingle / shake passing through the pair, the pair being mounted on the two rails.

5. The wood shingle / shake coater of claim 1, further comprising:
a bucket or vessel or pail, the bucket or vessel or pail having a top opening, the first rail and the second rail resting over the top opening of the bucket or vessel or pail.

6. The wood shingle / shake coater of claim 5, wherein the bucket or container or pail is configured to contain at most five gallons of coating.

7. A wood shingle / shake coater for efficiently and uniformly applying a coating liquid to a shingle or a shake, the coater comprising:
a first rail and a second rail in parallel relationship, the first and second parallel rails connected by two perpendicular brackets;
a first horizontal squeegee mounted to the first rail, and a second horizontal squeegee mounted to the second rail, the first and second horizontal squeegees in spaced and confronting relationship, a space between the first and second horizontal squeegees being less than a minimum thickness of a shingle / shake to be coated; and
a bucket or vessel or pail, the bucket or vessel or pail having a top opening, the first rail and the second rail resting over the top opening of the bucket or container or pail.

8. The wood shingle / shake coater of claim 7, wherein each of the two perpendicular brackets includes an adjustability feature configured to adjust the separation distance between the first horizontal squeegee and the second horizontal squeegee.

9. The wood shingle / shake coater of claim 7, further comprising:
a single vertical squeegee mounted on the first rail or the second rail, the single vertical squeegee configured to be used to remove excess coating from edges of the shingle / shake.

10. The wood shingle / shake coater of claim 7, wherein the bucket or container or pail can contain at most five gallons of coating.

11. The wood shingle / shake coater of claim 7, wherein each squeegee is replaced by a pair of:
brushes, or felt applicators, or foam applicators,
each pair being configured to remove excess liquid from a shingle / shake passing through the pair, the pair being mounted on the two rails.

12. The wood shingle / shake coater of claim 7, further comprising:
a sponge mounted on the first rail or the second rail, the sponge configured to be used to remove excess coating from edges of the shingle / shake.
